(19) United States
(12) Patent Application Publication
(10) Pub. No.: US 2011/0205481 A1
(43) Pub. Date: Aug. 25, 2011

(54) PIXEL CIRCUIT, LIQUID-CRYSTAL DEVICE, AND ELECTRONIC DEVICE

(75) Inventors: Shuji Aruga, Nagano (JP); Norio Koma, Gifu (JP); Koji Hirosawa, Aichi-Ken (JP)

(73) Assignee: SONY CORPORATION, Tokyo (JP)

(21) Appl. No.: 13/028,559

(22) Filed: Feb. 16, 2011

(30) Foreign Application Priority Data
Feb. 25, 2010 (JP) P2010-039782

(51) Int. Cl. G02F 1/1345

(52) U.S. Cl. 349/151

(57) ABSTRACT

A pixel circuit that is connected with a scanning line and a data line includes a first transistor of which a gate electrode is connected with the scanning line and one of a source electrode and a drain electrode is connected with the data line, a second transistor of which a gate electrode is connected with the scanning line, one of a source electrode and a drain electrode is connected with the first transistor, and the other one of the source electrode and the drain electrode is connected with a first node, an auxiliary capacitor connected with a node at which the first transistor and the second transistor are connected to each other, a pixel electrode connected with the first node, a counter electrode opposed to the pixel electrode, liquid crystal held between the pixel electrode and the counter electrode, and a holding capacitor connected with the first node.

### CROSS REFERENCES TO RELATED APPLICATIONS

The present application claims priority to Japanese Priority Patent Application JP 2010-039782 filed in the Japan Patent Office on Feb. 25, 2010, the entire contents of which are hereby incorporated by reference.

### BACKGROUND

The present application relates to a pixel circuit, a liquid-crystal device including the pixel circuit, and an electronic device including the liquid-crystal device.

Medium-sized and small-sized displays typified by a liquid-crystal display device are applied to many portable electronic devices (such as a mobile phone, a digital still camera, a digital video camera, a digital picture frame, and an electronic paper) due to their portability. Portable electronic devices are commonly driven by batteries, so that less power consumption of a display used in the portable electronic devices is demanded from the viewpoint of securement of operating time.

A liquid-crystal display device includes a plurality of pixels which are arranged in matrix. An image is displayed by writing a voltage corresponding to gradation which is to be displayed in each of the plurality of pixels and controlling transmittance of liquid crystal depending on the written voltage.

In order to reduce power consumption of a display, such a method that a driving frequency of pixels is lowered can be considered. However, if a driving frequency is lowered, an interval for writing a voltage in pixels is increased. Charges accumulated in a liquid-crystal capacitor are reduced with time due to leak current and therefore a potential of the pixels is lowered. Therefore, image quality of a display is deteriorated when the writing interval is increased. Accordingly, in order to lower a driving frequency and maintain image quality of a display, it is necessary to suppress leak current and maintain a voltage which is applied to liquid crystal.

Japanese Unexamined Patent Application Publication No. 10-111491 discloses a pixel circuit which suppresses leak current. This pixel circuit is configured such that two transistors are connected in series between a data line and a pixel electrode (liquid crystal) and a holding capacitor is connected to a node of the two transistors. Gates of the two transistors are connected to one scanning line. Accordingly, when a scanning signal is supplied to the scanning line during a writing period, the two transistors are turned on and a same voltage is written in the holding capacitor and a pixel capacitor of the liquid crystal. Subsequently, the two transistors are turned off. Here, the transistor which is connected to the data line is referred to as a first transistor, and the transistor which is connected to the pixel electrode (liquid crystal) is referred to as a second transistor. A level of leak current is increased when a voltage between a source and a drain is increased. However, the same voltage is written in the holding capacitor and the pixel capacitor, so that leak current of the second transistor can be suppressed.

### SUMMARY

However, in the related art pixel circuit, the holding capacitor may have a size enough to suppress the leak current of the second transistor. Thus, the holding capacitor and the pixel capacitor are not particularly optimized. Accordingly, the related art pixel circuit has such a problem that variation of a voltage applied to the pixel capacitor is not adequately suppressed.

It is preferable to provide a pixel circuit, a liquid-crystal device including the pixel circuit, and an electronic device including the liquid-crystal device. The pixel circuit includes an auxiliary capacitor, which has a layered structure for increasing capacitance per unit area, and is capable of minimizing variation of a potential applied to a liquid-crystal element by changing a ratio between capacitance values of the auxiliary capacitor and a holding capacitor and thus minimizing a leak current amount.

According to an, there is provided a pixel circuit that is connected with a scanning line and a data line and includes a first transistor of which a gate electrode is connected with the scanning line and one of a source electrode and a drain electrode is connected with the data line, a second transistor of which a gate electrode is connected with the scanning line, one of a source electrode and a drain electrode is connected with the first transistor, and the other one of the source electrode and the drain electrode is connected with a first node, an auxiliary capacitor that is connected with a node at which the first transistor and the second transistor are connected to each other, a pixel electrode that is connected with the first node, a counter electrode that is opposed to the pixel electrode, liquid crystal that is held between the pixel electrode and the counter electrode, and a holding capacitor that is connected with the first node. In the pixel circuit, a ratio between a capacitance value of the auxiliary capacitor and a capacitance value of the holding capacitor is set so as to minimize a change amount of a potential of the first node when the first transistor and the second transistor are turned off.

According to the, the ratio between the capacitance value of the auxiliary capacitor and the capacitance value of the holding capacitor is set so as to minimize the change amount of the potential of the first node when the first transistor and the second transistor are turned off. Even when the first transistor and the second transistor are in an off state, leak current corresponding to a voltage between the drain and the source of the transistors flows in the first transistor and the second transistor. The voltage applied between the drain and the source of the transistors varies depending on a capacitance value of a capacitor which is connected to the transistors. According to the embodiment, the ratio between the capacitance value of the auxiliary capacitor that is connected with the node at which the first transistor and the second transistor are connected to each other and the capacitance value of the holding capacitor that is connected with the first node to which the second transistor is connected is set so as to minimize the change amount of the potential of the first node. Accordingly, accuracy of displayed gradation can be improved.

Here, it is preferable that the ratio between the capacitance value of the auxiliary capacitor and the capacitance value of the holding capacitor be set such that the change amount of the potential of the first node can be minimized by minimizing a total leak current amount of an amount of leak current, which decreases as the capacitance value of the auxiliary capacitor increases, of the first transistor and the second transistor and an amount of leak current that is generated between the pixel electrode and the counter electrode and decreases as the capacitance value of the holding capacitor increases. In this case, the total leak current amount is minimized based on the amount of leak current, which decreases as the capacitance value of the auxiliary capacitor increases, of the first transistor and the second transistor and the amount of leak current that is generated between the pixel electrode and the counter electrode and decreases as the capacitance value of the holding capacitor increases. Therefore, the ratio between the capacitance value of the auxiliary capacitor and the capacitance value of the holding capacitor can be more efficiently set and accordingly, the change amount of the potential of the first node can be more efficiently minimized.

Further, it is preferable that N (N is an integer number of 3 or more) pieces of transistors be connected in series between the data line and the first node instead of the first transistor and the second transistor, a gate electrode of the N pieces of transistors be connected with the scanning line, one electrode of N−1 pieces of auxiliary capacitors, instead of the auxiliary capacitor, be connected to each of a plurality of nodes at which the N pieces of transistors are connected to each other, and a ratio between each capacitance value of the N−1 pieces of auxiliary capacitors and the capacitance value of the holding capacitor be set so as to minimize the change amount of the potential of the first node when the N pieces of transistors are turned off. In this case, the transistors are connected in multiple stages, so that the magnitude of leak current of the transistor that is connected to the first node can be further reduced.

It is preferable that the auxiliary capacitor include one electrode that is connected with the pixel electrode and other electrodes that are disposed on an upper layer side and a lower layer side of the one electrode with dielectrics interposed respectively. In this case, the capacitance value of the auxiliary capacitor per unit area can be increased by the layered structure of the electrode. Thus, the capacitance value of the auxiliary capacitor can be varied more flexibly, whereby the ratio between the capacitance value of the auxiliary capacitor and the capacitance value of the holding capacitor can be set adequately. It is preferable that the liquid crystal be memory-type liquid crystal. In this case, an image can be maintained for a longer period of time than a case where common liquid crystal is used. It is preferable that a signal supplied from the data line to the pixel circuit be a binary signal that is on either one level between two levels. In this case, a kind of a signal that drives the data line may be a binary signal. Therefore, a driving method is simpler than a case where a binary or more signal is used, and the driving circuit can be simplified.

A liquid-crystal device according to another embodiment includes a plurality of scanning lines, a plurality of data lines, a plurality of pixel circuits that are provided in a manner to correspond to intersections of the scanning lines and the data lines, and a driving circuit configured to drive the plurality of pixel circuits. In the liquid-crystal device, each of the plurality of pixel circuits is the pixel circuit described in the above embodiment. An electronic device according to still another embodiment includes the liquid-crystal device described in the above embodiment.

Additional features and advantages are described herein, and will be apparent from the following Detailed Description and the figures.

### BRIEF DESCRIPTION OF THE FIGURES

FIG. 1 is a block diagram showing the schematic configuration of an electrooptic device according to an embodiment;

FIG. 2 is a circuit diagram showing the configuration of a pixel circuit in the electrooptic device;

FIG. 3 is a graph showing a transmission characteristic of a TFT in the electrooptic device;

FIG. 4 is a graph showing a characteristic of leak current of the TFT in the electrooptic device;

FIG. 5 is a graph showing a relationship between an applied voltage and transmittance in a liquid-crystal element in the electrooptic device;

FIG. 6 schematically illustrates a screen displayed in a display region in the electrooptic device;

FIG. 7 illustrates a relationship among a driving frequency, a ratio between a capacitance value of an auxiliary capacitor and a capacitance value of a holding capacitor, and a leak current value in the electrooptic device;

FIG. 8 illustrates a relationship among a driving frequency, a ratio between a capacitance value of the auxiliary capacitor and a capacitance value of the holding capacitor, and a leak current value in the electrooptic device;

FIG. 9 illustrates a relationship among a driving frequency, a ratio between a capacitance value of the auxiliary capacitor and a capacitance value of the holding capacitor, and a leak current value in the electrooptic device;

FIG. 10 is a transverse sectional view of the auxiliary capacitor in the electrooptic device;

FIG. 11 is a circuit diagram showing the configuration of a pixel circuit of an electrooptic device according to a modification of the embodiment;

FIG. 12 illustrates comparison among drive-enabling frequencies of pixel circuits;

FIG. 13 is a perspective view showing the configuration of a mobile-type personal computer to which the electrooptic device is applied;

FIG. 14 is a perspective view showing the configuration of a mobile telephone to which the electrooptic device is applied; and

FIG. 15 is a perspective view showing the configuration of a personal digital assistant to which the electrooptic device is applied.

### DETAILED DESCRIPTION

Embodiments of the present application will be described below in detail with reference to the drawings.

### 1. Embodiment

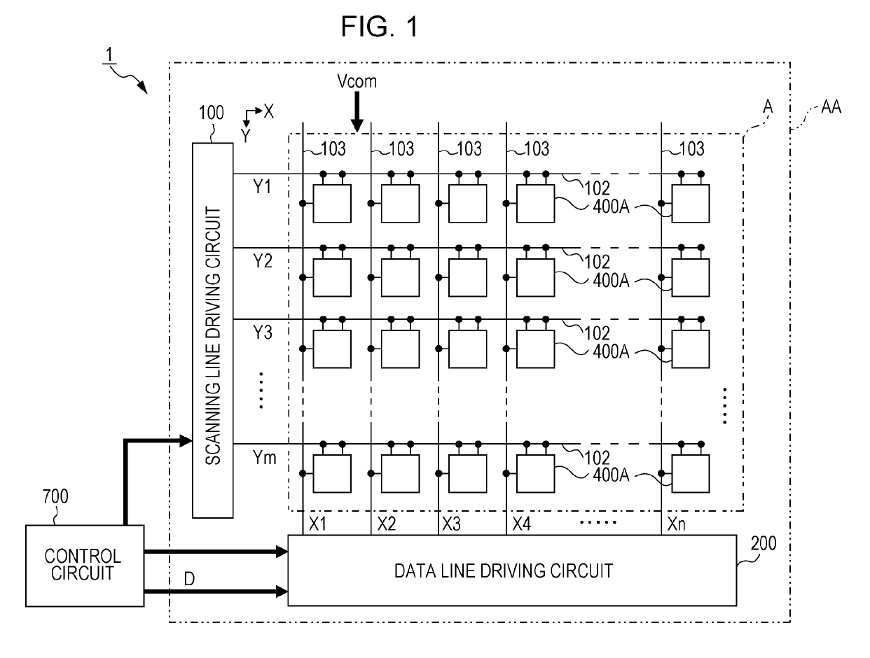

FIG. 1 is a block diagram showing the schematic configuration of an electrooptic device according to an embodiment. This electrooptic device 1 includes an electrooptic panel AA and a control circuit 700. On the electrooptic panel AA, a display region A, a scanning line driving circuit 100, and a data line driving circuit 200 are formed. In the display region A, m pieces of scanning lines 102 are formed in parallel with an X direction. Further, n pieces of data lines 103 are formed in parallel with a Y direction which is orthogonal to the X direction. Further, pixel circuits 400A are provided in a manner to correspond to respective intersections of the scanning lines 102 and the data lines 103.

The scanning line driving circuit 100 generates scanning signals Y1, Y2, Y3, . . . , Ym for sequentially selecting the plurality of scanning lines 102.

The data line driving circuit 200 supplies data signals X1, X2, X3, . . . , Xn respectively to the pixel circuits 400A which are positioned on the selected scanning lines 102. In this example, the data signals X1 to Xn are supplied as voltage signals instructing gradation luminance.

The control circuit 700 generates various control signals and outputs the signals to the scanning line driving circuit 100 and the data line driving circuit 200. Further, the control circuit 700 generates gradation data D to which image processing such as gamma compensation is executed and outputs the gradation data D to the data line driving circuit 200. Though the control circuit 700 is provided outside the electrooptic panel AA in this example, a part or the whole of these constituent elements may be taken in the electrooptic panel AA. Further, a part of the constituent elements provided on the electrooptic panel AA may be provided as an external circuit.

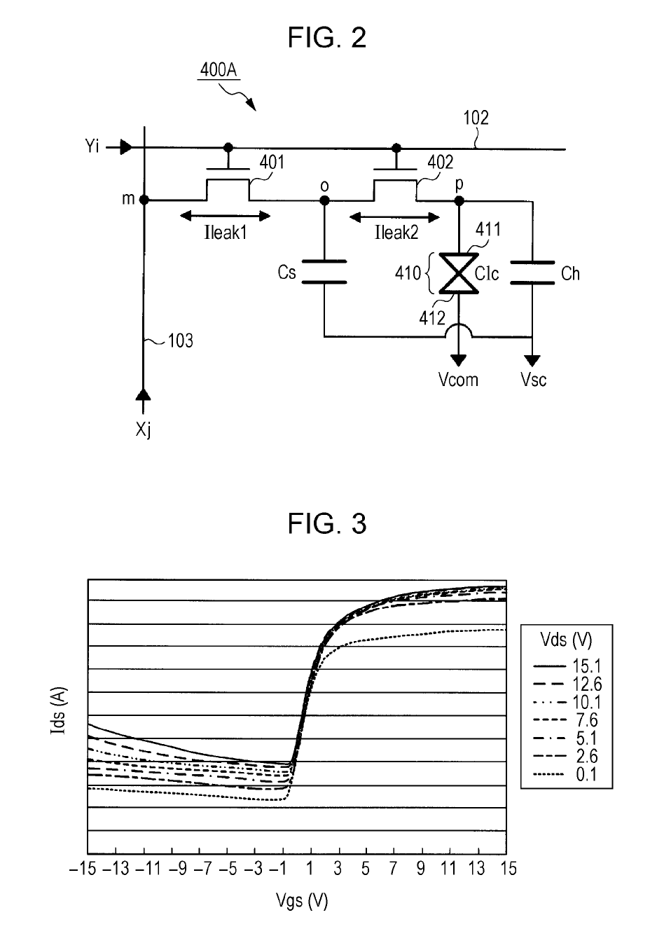

FIG. 2 is a circuit diagram of the pixel circuit 400A according to the embodiment. The pixel circuit 400A is provided on a row i (i is a positive integer which satisfies 1≦i≦m) and on a column j (j is a positive integer which satisfies 1≦j≦n) of the display region A. To the pixel circuit 400A, a data signal Xj and a scanning signal Yi are supplied respectively from the data line 103 and the scanning line 102. The pixel circuit 400A includes two thin film transistors (referred to below as TFTs) 401 and 402, an auxiliary capacitor Cs, a holding capacitor Ch, and a liquid-crystal element 410. A source electrode of the TFT 401 is connected to the data line 103 via a node m. A drain electrode of the TFT 401 is connected to a source electrode of the TFT 402 and the auxiliary capacitor Cs via a node o. A drain electrode of the TFT 402 is connected to the liquid-crystal element 410 and the holding capacitor Ch via a node p. Gate electrodes of the TFT 401 and the TFT 402 are connected to the scanning line 102.

While one end of the auxiliary capacitor Cs is connected to the drain electrode of the TFT 401 and the source electrode of the TFT 402, the other end of the auxiliary capacitor Cs is connected to a counter electrode (not shown) via a node q. The liquid-crystal element 410 is composed of a pixel electrode 411, a counter electrode 412, and liquid crystal Clc which is held between the pixel electrode 411 and the counter electrode 412. Here, the counter electrode 412 is common in other pixel circuits 400A, and a common potential Vcom is supplied to the counter electrode 412.

While one ends of the liquid-crystal element 410 and the holding capacitor Ch are respectively connected to the drain electrode of the TFT 402, the other ends of the liquid-crystal element 410 and the holding capacitor Ch are connected to a counter electrode (not shown) via the node q.

The liquid crystal Clc may be memory-type liquid crystal. The memory-type liquid crystal is stable in both of a light transmitting state and a no-light transmitting state, that is, the memory-type liquid crystal has a bistable property. Liquid crystal is categorized into “nematic liquid crystal”, “cholesteric liquid crystal”, and “smectic liquid crystal” depending on a molecular arrangement. Any type of these includes liquid crystal having an excellent holding characteristic. For example, a product manufactured by using “cholesteric liquid crystal” and a product manufactured by using a kind of smectic liquid crystal which is ferroelectric liquid crystal (FLC) and has liquid crystal molecules having a spiral structure are common. By using memory-type liquid crystal for the liquid crystal Clc, an image can be maintained for a longer period of time than a case where common liquid crystal is used.

FIG. 3 is a graph showing a transmission characteristic of a TFT which is used in the embodiment. X axis indicates a value of a gate-source voltage and Y axis indicates a value of drain-source current. Curves on the graph respectively indicate transmission characteristics under different drain-source voltages.

When a gate-source voltage (Vgs) varies from a negative value to a positive value and exceeds a threshold voltage, drain-source current (Ids) sharply rises. Further, as the drain-source voltage (Vds) decreases, the drain-source current (Ids) also decreases. However, even when the gate-source voltage (Vgs) becomes equal to or less than the threshold voltage to have a negative value, the drain-source current (Ids) flows. This means that leak current flows in an actual circuit even in an off state of the TFT.

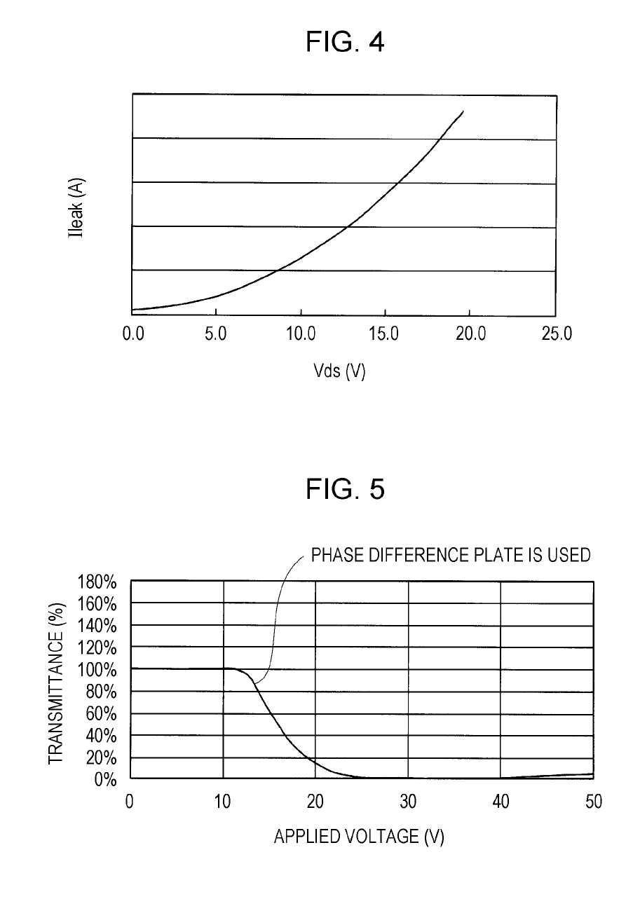

FIG. 4 is a graph showing a characteristic of leak current of the TFT which is used in the embodiment. X axis indicates a value of a drain-source voltage (Vds) and Y axis indicates a value of leak current (Ileak). As the value of the drain-source voltage Vds decreases, the value of the leak current Ileak decreases. Accordingly, it is understood that leak current of the TFT can be suppressed by reducing a voltage between the drain electrode and the source electrode.

FIG. 5 is a graph showing a relationship between an applied voltage and transmittance in a liquid-crystal element which is used in the embodiment. X axis indicates a value of a voltage which is applied to the liquid-crystal element and Y axis indicates transmittance of the liquid-crystal element. In a case where a phase difference plate is not used and a case where an applied voltage is low (0 V to about 10 V), the transmittance is maintained at approximately 100%. The transmittance once rises in accordance with a rise of the applied voltage (about 10 V to 14 V), and falls in accordance with a further rise of the applied voltage (about 14 V or more) and reaches 0. In a case where the phase difference plate is used and a case where the applied voltage is low (0 V to about 10 V), the transmittance is maintained at approximately 100%. The transmittance falls in accordance with a rise of the applied voltage (about 10 V or more) and then the transmittance reaches 0. In any cases, it is necessary to increase the applied voltage so as to make the transmittance of the liquid-crystal element be 0.

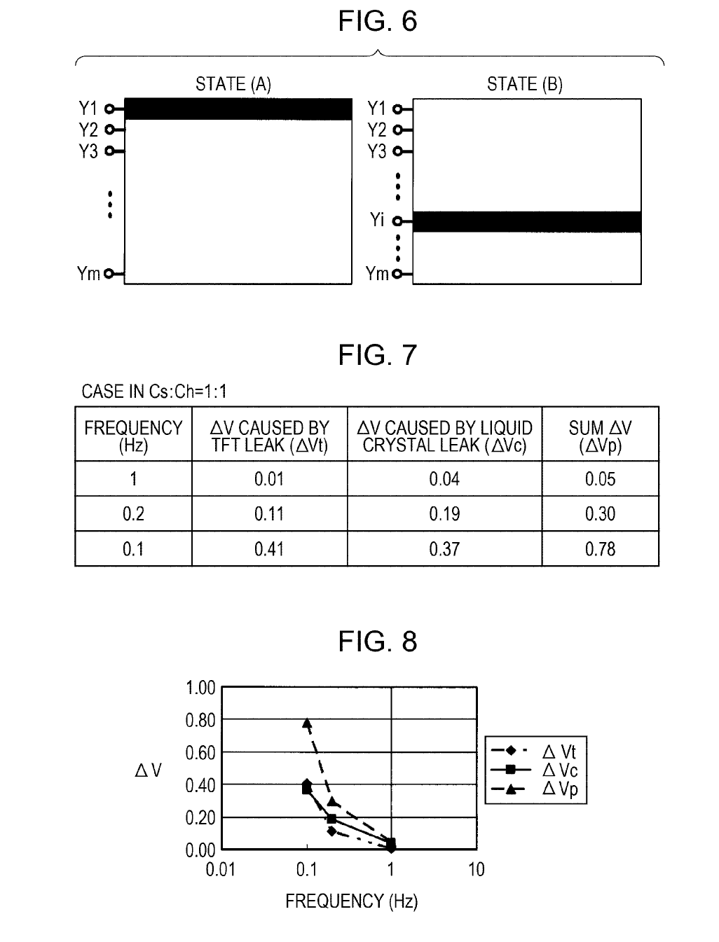

FIG. 6 schematically illustrates a screen which is displayed on the display region A of the embodiment. In state (A), all pixels to which the scanning signal Y1 is supplied display black, and all other pixels display white. In state (B), all pixels to which the scanning signal Yi is supplied display black, and all other pixels display white. The transmittance of the pixels which display black is 0%, and the transmittance of the pixels which display white is 100%. In this example, the data signal Xj is a binary signal indicating lighting or turn-off. Gradation display of each of the pixels is executed by sub-field drive for controlling lighting and turn-off in each of a plurality of sub fields which are obtained by dividing a field.

In such the pixel circuit 400A, it is assumed that a voltage on the node p and the node o is 30 V and a voltage on the node m is 10 V at time when writing of a voltage, which corresponds to a gradation, to the pixel circuit 400A is finished. In this case, since the voltage between the node m and the node o is 20 V, the drain-source voltage Vds of the TFT 401 is 20 V and the leak current Ileak1 flows (refer to FIG. 4).

On the other hand, since a voltage between the node o and the node p is 0 V, the leak current Ileak2 does not flow in the TFT 402. The voltage on the node o gradually becomes closer to the voltage on the node m. Here, when the change amount of the voltage on the node o is denoted as ΔV, ΔV=Ileak1×ΔT(holding time)/Csc1 can be expressed. For example, when a driving frequency is 4 Hz and Csc1=200 fF, the change amount becomes about 2 V. Accordingly, a final voltage on the node o becomes about 28 V. Thus, leak current Ileak2 of the TFT 402 can be suppressed by lowering the voltage between the node o and the node p. As a result, a driving frequency can be lowered, whereby power consumption can be lowered.

Next, a relationship among a driving frequency, a ratio between capacitance values of the auxiliary capacitor Cs and the holding capacitor Ch, and leak current of the pixel circuit 400A used in the embodiment is described in reference to FIGS. 7 to 9.

FIGS. 7 and 8 illustrate a magnitude of potential variation ΔVp on the node p of a case where a driving frequency is varied. The magnitude of the potential variation ΔVp is a sum of potential variation ΔVt caused by leak current generated between the source and the drain of the TFT 401 and between the source and the drain of the TFT 402 and potential variation ΔVc caused by leak current generated between the pixel electrode 411 and the counter electrode 412 of the liquid-crystal element 410. The potential variation ΔVt and the potential variation ΔVc vary depending on capacitance values of the auxiliary capacitor Cs and the holding capacitor Ch. However, a ratio between the capacitance values of the auxiliary capacitor Cs and the holding capacitor Ch is fixed at 1:1 in FIGS. 7 and 8. FIG. 8 is a graph which is obtained from the table of FIG. 7. As shown in FIGS. 7 and 8, ΔVt, ΔVc, and ΔVp which is the sum of ΔVt and ΔVc rise as the driving frequency falls. For example, when the driving frequency is 1 Hz, ΔVt=0.01, ΔVc=0.04, and ΔVp=0.05. When the driving frequency falls to be 0.2 Hz, the potential variations rise respectively as ΔVt=0.11, ΔVc=0.19, and ΔVp=0.30.

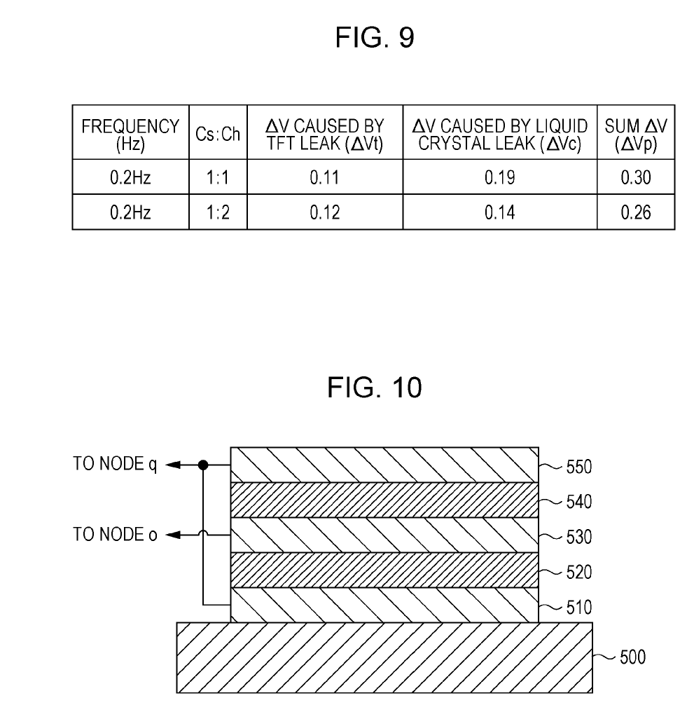

FIG. 9 illustrates a magnitude of potential variation ΔVp on the node p of a case where the driving frequency is fixed at 0.2 Hz and a ratio between the capacitance values of the auxiliary capacitor Cs and the holding capacitor Ch is varied. The sum of the capacitance values of the auxiliary capacitor Cs and the holding capacitor Ch (the sum is referred to below as S) is constant even when the ratio between the capacitance values of the auxiliary capacitor Cs and the holding capacitor Ch is varied. As is the case with FIGS. 7 and 8, the magnitude of the potential variation ΔVp on the node p is the sum of ΔVt and ΔVc.

As shown in FIG. 9, when the ratio between the capacitance values of the auxiliary capacitor Cs and the holding capacitor Ch is varied from 1:1 to 1:2, that is, when the capacitance value of the auxiliary capacitor Cs is decreased and the capacitance value of the holding capacitor Ch is increased, the potential variation ΔVt caused by leak current of the TFT 401 and the TFT 402 rises from 0.11 to 0.12, while the potential variation ΔVc caused by leak current of the liquid-crystal element 410 falls from 0.19 to 0.14. Consequently, ΔVp which is the sum of ΔVt and ΔVc falls from 0.30 to 0.26.

As described above, the sum S of the capacitance values of the auxiliary capacitor Cs and the holding capacitor Ch is constant. Therefore, when the capacitance value of the auxiliary capacitor Cs is increased, the capacitance value of the holding capacitor Ch falls, and when the capacitance value of the holding capacitor Ch is increased, the capacitance value of the auxiliary capacitor Cs falls. That is, the capacitance value of the holding capacitor Ch and the capacitance value of the auxiliary capacitor Cs are in a trade-off relationship.

Further, as shown in FIG. 9, when the capacitance value of the auxiliary capacitor Cs is increased, leak current of the TFT 401 and the TFT 402 which are connected to the auxiliary capacitor Cs is lowered and therefore ΔVt falls. When the capacitance value of the holding capacitor Ch is increased, leak current of the liquid-crystal element 410 which is connected to the holding capacitor Ch is lowered and therefore ΔVc falls. That is, ΔVt varies inversely to the capacitance value of the auxiliary capacitor Cs, and ΔVc varies inversely to the capacitance value of the holding capacitor Ch. The change rate of ΔVt and the change rate of ΔVc are not same as each other, so that the potential variation ΔVp (=ΔVt+ΔVc) on the node p can be minimized by striking a balance between the capacitance value of the auxiliary capacitor Cs and the capacitance value of the holding capacitor Ch.

As described above, potential variation caused by generation of leak current can be controlled by varying the ratio between the capacitance values of the auxiliary capacitor Cs and the holding capacitor Ch under a certain driving frequency even in a state that the capacitance value of the whole circuit is constant. Namely, by varying the capacitance values of the auxiliary capacitor Cs and the holding capacitor Ch and thus striking a balance between a leak current amount of the TFT and a leak current amount of the liquid-crystal element under a certain driving frequency, the potential variation ΔVp which influences a potential applied to the liquid-crystal element can be controlled and, for example, the potential variation ΔVp can be minimized.

The configuration of the auxiliary capacitor used in the embodiment is next described.

It is common that integration of a pixel circuit used in a display is demanded, so that an area which can be used for the pixel circuit is limited. Therefore, it is difficult to enlarge an area of the auxiliary capacitor included in the pixel circuit and to vary the capacitance value so as to vary the ratio between the capacitance values of the auxiliary capacitor Cs and the holding capacitor Ch described above. Accordingly, it is demanded to increase the capacitance value while suppressing the area of the auxiliary capacitor.

FIG. 10 is a transverse sectional view of the auxiliary capacitor Cs used in the embodiment. On a substrate 500, a source wiring metal layer 510, an insulation layer 520 (dielectric), a gate wiring metal layer 530, an insulation layer 540 (dielectric), and a source wiring metal layer 550 are layered in this order from one closer to the substrate 500. The source wiring metal layer 510 and the source wiring metal layer 550 are short-circuited and are connected to the node q in FIG. 2. The gate wiring metal layer 530 is connected to the node o in FIG. 2.

That is, though a common auxiliary capacitor is composed of a single source wiring metal layer, a single insulation layer, and a single gate wiring metal layer, the auxiliary capacitor used in this embodiment has a layered structure in which the insulation layers 520 and 540 are respectively provided on the both sides sandwiching the gate wiring metal layer 530 and the source wiring metal layers 510 and 550 are also respectively provided on the both sides sandwiching the gate wiring metal layer 530 so as to increase a capacitance per unit area. By structuring as this, the capacitance per unit area can be approximately doubled.

By using such the auxiliary capacitor, the capacitance value of the auxiliary capacitor can be varied and the ratio between the capacitance value of the holding capacitor Ch and the capacitance value of the auxiliary capacitor Cs can be varied without increasing the size of the pixel circuit.

### 2. Modification

The pixel circuit 400A includes two TFTs in the embodiment described above. However, the embodiment is not limited to this but can be applied to a pixel circuit including three or more TFTs.

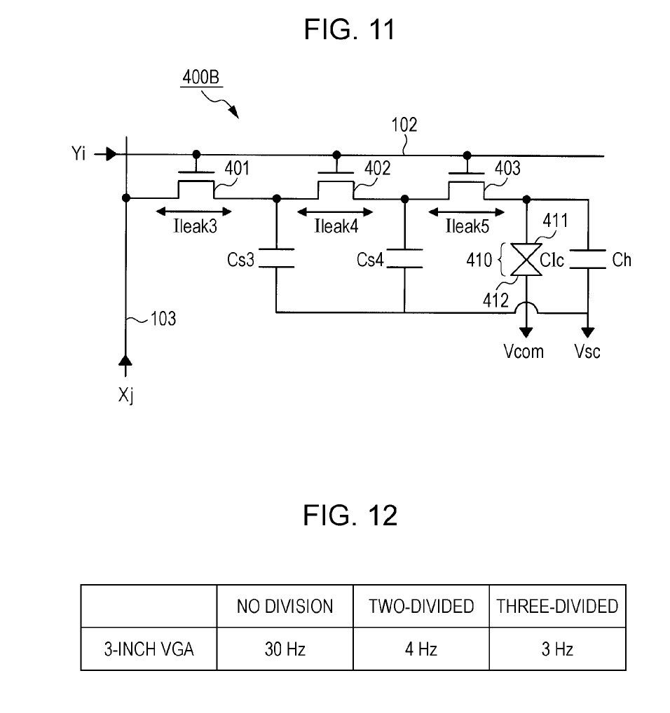

FIG. 11 is a circuit diagram of a pixel circuit 400B according to a modification of the embodiment. The pixel circuit 400B is provided on a row i (i is a positive integer which satisfies 1≦i≦m) and on a column j (j is a positive integer which satisfies 1≦j≦n) of the display region A. To the pixel circuit 400B, a data signal Xj and a scanning signal Yi are supplied respectively from the data line 103 and the scanning line 102. The pixel circuit 400B includes three TFTs 401, 402, and 403, two auxiliary capacitors Cs3 and Cs4, a holding capacitor Ch, and a liquid-crystal element 410. The source electrode of the TFT 401 is connected to the data line 103. The drain electrode of the TFT 401 is connected to the source electrode of the TFT 402 and the auxiliary capacitor Cs3. The drain electrode of the TFT 402 is connected to a source electrode of the TFT 403 and the auxiliary capacitor Cs4. A drain electrode of the TFT 403 is connected to the liquid-crystal element 410 and the holding capacitor Ch. Gate electrodes of the TFTs 401, 402, and 403 are connected to the scanning line 102.

While one end of the auxiliary capacitor Cs3 is connected to the drain electrode of the TFT 401 and the source electrode of the TFT 402, the other end of the auxiliary capacitor Cs3 is connected to a counter electrode (not shown). While one end of the auxiliary capacitor Cs4 is connected to the drain electrode of the TFT 402 and the source electrode of the TFT 403, the other end of the auxiliary capacitor Cs4 is connected to a counter electrode (not shown). While one ends of the liquid-crystal element 410 and the holding capacitor Ch are respectively connected to the drain electrode of the TFT 403, the other ends of the counter electrode 412 of the liquid-crystal element 410 and the holding capacitor Ch are connected to a counter electrode (not shown). From the counter electrode, a common potential Vcom is supplied.

Operation of the pixel circuit 400B configured in a three-divided fashion and shown in FIG. 11 is according to an operation of the above-described pixel circuit 400A configured in a two-divided fashion and shown in FIG. 2. The pixel circuit 400B includes auxiliary capacitors one piece more than the pixel circuit 400A configured in the two-divided fashion and shown in FIG. 2, so that the pixel circuit 400B can further suppress generation of leak current.

FIG. 12 illustrates comparison among drive-enabling frequencies of a related art pixel circuit having no division, a two-divided pixel circuit shown in FIG. 2, and a three-divided pixel circuit shown in FIG. 11, in a 3-inch video graphics array (VGA) display. Here, a total capacitance value of capacitors included in each of the pixel circuits is constant.

As described above, when the driving frequency is lowered, an interval for writing a voltage in the pixel circuit is increased. Electric charges accumulated in a liquid-crystal capacitor are reduced with time due to leak current and therefore a potential of a pixel is lowered. Therefore, image quality of a display is deteriorated when the writing interval is increased. Namely, a driving frequency for maintaining a certain level of image quality of the display rises as leak current is easily generated. Since leak current is easily generated in the pixel circuit having no division, a drive-enabling frequency has a high value, namely, 30 Hz. Since leak current is further suppressed in the two-divided pixel circuit than the pixel circuit having no division, the two-divided pixel circuit can be driven by a lower frequency, namely, 4 Hz. Since leak current is furthermore suppressed in the three-divided pixel circuit than the two-divided pixel circuit, the three-divided pixel circuit can be driven by a further lower frequency, namely, 3 Hz. Thus, even though the capacitance value of the whole pixel circuit is constant, a drive-enabling frequency can be suppressed low by increasing a division number of the pixel circuit, and accordingly, the power consumption can be reduced.

### 3. Application

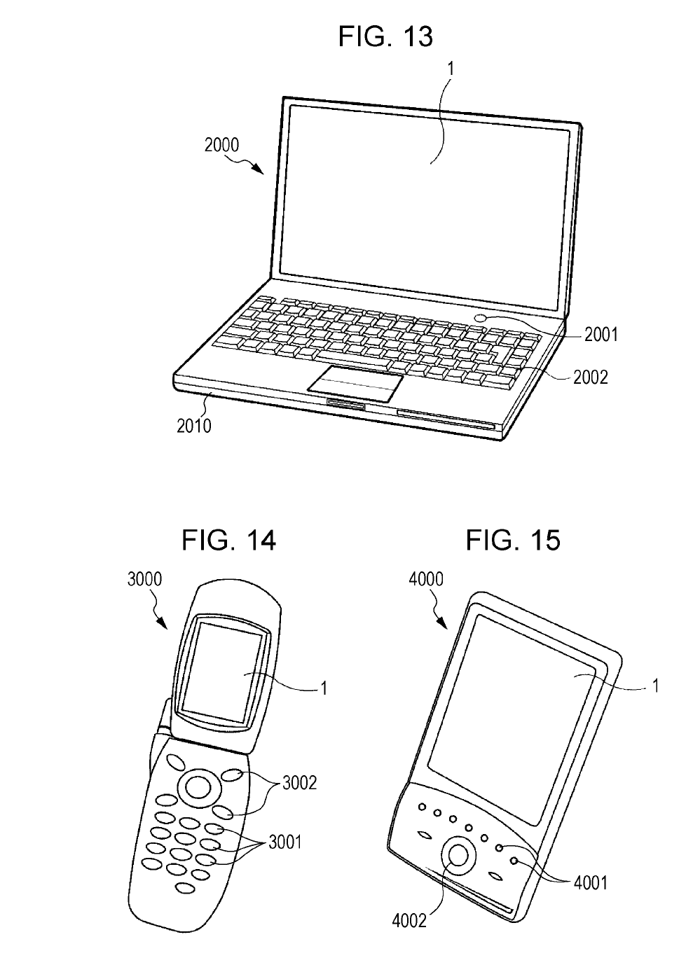

Electronic devices to which the electrooptic device 1 according to the above-described embodiment is applied are next described. FIG. 13 illustrates the configuration of a mobile-type personal computer to which the electrooptic device 1 is applied. This personal computer 2000 includes the electrooptic device 1 serving as a display unit and a main body 2010. The main body 2010 is provided with a power switch 2001 and a keyboard 2002.

FIG. 14 illustrates the configuration of a mobile telephone to which the electrooptic device 1 is applied. This mobile telephone 3000 includes a plurality of operation buttons 3001, a plurality of scroll buttons 3002, and the electrooptic device 1 serving as a display unit. A screen displayed on the electrooptic device 1 is scrolled by operating the scroll buttons 3002.

FIG. 15 illustrates the configuration of a personal digital assistant (PDA) to which the electrooptic device 1 is applied. This personal digital assistant 4000 includes a plurality of operation buttons 4001, a power switch 4002, and the electrooptic device 1 serving as a display unit. When the power switch 4002 is operated, various types of information such as an address list and a diary are displayed on the electrooptic device 1.

Examples of electronic devices to which the electrooptic device 1 is applied include a digital still camera, a digital picture frame, an electronic paper, a liquid-crystal television, viewfinder-type and monitor direct-view-type videotape recorders, a monitor direct-view-type digital video camera, a car navigation device, a pager, an electronic diary, a calculator, a word processor, a workstation, a videophone, a POS terminal, and devices including a touch panel as well as the devices shown in FIGS. 13 to 15. The electrooptic device 1 described above is applicable as a display unit of these various types of electronic devices.

It should be understood that various changes and modifications to the presently preferred embodiments described herein will be apparent to those skilled in the art. Such changes and modifications can be made without departing from the spirit and scope and without diminishing its intended advantages. It is therefore intended that such changes and modifications be covered by the appended claims.

The application is claimed as follows:

1. A pixel circuit that is connected with a scanning line and a data line, comprising:
a first transistor of which a gate electrode is connected with the scanning line and one of a source electrode and a drain electrode is connected with the data line;
a second transistor of which a gate electrode is connected with the scanning line, one of a source electrode and a drain electrode is connected with the first transistor, and the other one of the source electrode and the drain electrode is connected with a first node;
an auxiliary capacitor that is connected with a node at which the first transistor and the second transistor are connected to each other;
a pixel electrode that is connected with the first node;
a counter electrode that is opposed to the pixel electrode;
liquid crystal that is held between the pixel electrode and the counter electrode; and
a holding capacitor that is connected with the first node; wherein
a ratio between a capacitance value of the auxiliary capacitor and a capacitance value of the holding capacitor is set so as to minimize a change amount of a potential of the first node when the first transistor and the second transistor are turned off

2. The pixel circuit according to claim 1, wherein the ratio between the capacitance value of the auxiliary capacitor and the capacitance value of the holding capacitor is set such that the change amount of the potential of the first node can be minimized by minimizing a total leak current amount of an amount of leak current, the amount of leak current decreasing as the capacitance value of the auxiliary capacitor increases, of the first transistor and the second transistor and an amount of leak current that is generated between the pixel electrode and the counter electrode and decreases as the capacitance value of the holding capacitor increases.

3. The pixel circuit according to claim 1, wherein
N, the N being an integer number of 3 or more, pieces of transistors are connected in series between the data line and the first node instead of the first transistor and the second transistor,
a gate electrode of the N pieces of transistors is connected with the scanning line,
one electrode of N−1 pieces of auxiliary capacitors, instead of the auxiliary capacitor, is connected to each of a plurality of nodes at which the N pieces of transistors are connected to each other, and
a ratio between each capacitance value of the N−1 pieces of auxiliary capacitors and the capacitance value of the holding capacitor is set so as to minimize the change amount of the potential of the first node when the N pieces of transistors are turned off.

4. The pixel circuit according to claim 1, wherein the auxiliary capacitor includes one electrode that is connected with the pixel electrode and other electrodes that are disposed on an upper layer side and a lower layer side of the one electrode with dielectrics interposed respectively.

5. The pixel circuit according to claim 1, wherein the liquid crystal is memory-type liquid crystal.

6. The pixel circuit according to claim 1, wherein a signal supplied from the data line to the pixel circuit is a binary signal that is on either one level between two levels.

7. A liquid-crystal device, comprising:
a plurality of scanning lines;
a plurality of data lines;
a plurality of pixel circuits that are provided in a manner to correspond to intersections of the scanning lines and the data lines; and
a driving circuit configured to drive the plurality of pixel circuits; wherein
each of the plurality of pixel circuits is the pixel circuit of any one of claims 1 to 6.

8. An electronic device, comprising:
the liquid-crystal device of claim 7.
